(19) United States
(12) Patent Application Publication
(10) Pub. No.: US 2024/0320290 A1
(43) Pub. Date: Sep. 26, 2024

(54) Method for learning a prediction algorithm and associated devices

(71) Applicant: THALES, COURBEVOIE (FR)

(72) Inventor: Pierre-Yves LAGRAVE, PALAISEAU (FR)

(21) Appl. No.: 18/575,297

(22) PCT Filed: Jun. 30, 2021
(86) PCT No.: PCT/EP2022/068153

§ 371 Date: Dec. 28, 2023

(30) Foreign Application Priority Data
Jun. 30, 2021 (FR) 2107019

(51) Int. Cl. G06F 17/11

(52) U.S. Cl. CPC G06F 17/11

(57) ABSTRACT

A method for learning a prediction algorithm, the learning being implemented by a machine learning technique, the method including reception of a current set of learning data, reception of an invariance property of the prediction of the algorithm with respect to the inputs according to an initial symmetry group endowed with an initial probability law, determination of a subgroup of the initial group endowed with a subgroup probability law and intended to apply transformations to the current set, according to an optimization technique using the current set, the initial group and the initial law under an optimization constraint deduced from predetermined constraints, generation of data using the determined subgroup, the law of the subgroup and the whole current set, and implementation of a learning of the algorithm using the generated data.

### CROSS-REFERENCE TO RELATED APPLICATIONS

This application claims benefit under 35 USC § 371 of PCT Application No. PCT/EP2022/068153 entitled METHOD FOR TRAINING A PREDICTION ALGORITHM AND ASSOCIATED DEVICES, filed on Jun. 30, 2022 by inventor Pierre-Yves Lagrave. PCT Application No. PCT/EP2022/068153 claims priority of French Patent Application No. 21 07019, filed on Jun. 30, 2021.

### FIELD OF THE INVENTION

The present invention relates to a method for learning a prediction algorithm. The relates to a computer product program and to an associated readable storage medium.

### TECHNOLOGICAL BACKGROUND OF THE INVENTION

The present invention is in the field of developing predictive algorithms which have been learned using a machine learning technique.

In French, machine learning is referred to by many different terms such as the English term “machine learning”, the term “automatic learning”, the term “artificial learning” or the term “statistical learning”. Machine learning involves using data to learn a predictive algorithm.

However, as a result therefrom, a very large dataset is needed, which is difficult in practice.

For this purpose, techniques for increasing the data of a dataset are known.

Depending on the type of data, different transformations can be envisaged for the construction of an augmented dataset, such as geometric transformations or changes of colors and/or sizes within images.

Applying a series of transformations to the elements of a dataset is a strategy of augmentation. Thereby, applying random angle rotations to the elements of a set of images is a strategy, just like applying color changes to each element of the set under consideration.

However, such an approach is often not viable in practice because of the presence of exogenous constraints, such as restrictions on the memory footprint of the learned algorithm, on the execution time thereof on the target architecture or on the degree of robustness to modifications of the inputs thereof.

### SUMMARY OF THE INVENTION

There is thus a need for a method of learning a prediction algorithm apt to be implemented by a real system on a dataset of small size.

For this end, the description describes a method for learning a prediction algorithm, the prediction algorithm predicting for given inputs the value of one or a plurality of outputs, the learning being implemented by using a machine learning technique and, the method of learning including the steps of:
reception of a current set of learning data,
reception of at least one invariance property of the prediction algorithm to be learned with respect to the inputs that the prediction algorithm can take as input according to a symmetry group, called an initial symmetry group, said symmetry group being provided with an initial probability law,
determination of a subgroup of the initial symmetry group, the subgroup being provided with a probability law, called the subgroup probability law, the subgroup corresponding to transformations of the inputs given to the prediction algorithm, the subgroup being intended to be used for generating learning data by applying the corresponding transformations to the current learning dataset according to the subgroup probability law, the subgroup and the subgroup probability law being determined according to an optimization technique under at least one optimization constraint, the optimization technique using the initial learning dataset, the initial symmetry group and the initial probability law, the at least one optimization constraint being derived from at least one predetermined learning constraint,
generation of data using the determined subgroup, the subgroup probability law and the entire current learning dataset, for obtaining generated data, and
implementation of a learning of the prediction algorithm using the generated data, the learning being:
   either a learning using an iterative data generation technique, each iteration comprising the generation step, the implementation step being carried out with only the generated data, the current learning dataset used then being the dataset generated at the current iteration,
   or a learning using a dataset formed by the dataset generated and an initial dataset, the initial dataset being used as the current learning dataset.

According to particular embodiments, the method for learning has one or a plurality of the following features, taken individually or according to all technically possible combinations:
the input(s) and/or output(s) are physical quantities corresponding to measurements coming from one or a plurality of sensors,
the prediction algorithm is an image processing algorithm.
the prediction algorithm is a pattern recognition algorithm or an image classification algorithm.
the at least one predetermined learning constraint is chosen from the list consisting of:
   the memory fingerprint of the learned algorithm,
   the execution time of the algorithm learned on a predetermined system,
   the amount of calculation which can be done on a predetermined system on which the learned algorithm is intended to be used,
   a constraint of confidentiality of certain data,
   a security constraint, the degree of robustness of the learned algorithm to changes of inputs, and
   the learning time of the prediction algorithm.
at least [one] constraint is the learning time of the prediction algorithm.
the optimization technique consists in minimizing, under optimization constraint, the difference in prediction error between the prediction algorithm obtained using learning data comprising data generated from the initial symmetry group and the initial probability law, and the prediction algorithm obtained using learning data comprising data generated from the determined subgroup and the subgroup probability law.
a plurality of optimization constraints are taken into account in the optimization technique.
the optimization technique is an optimization of a quadratic target function under quadratic optimization constraints.
the subgroup has a dimension, at least one constraint being a limitation of at least one moment of the subgroup probability law with a bound, in particular an upper bound on the dimension of the subgroup or an upper bound on the variance of the subgroup probability law.
the initial probability law is obtained from the likelihood of the transformations associated with the initial symmetry group measured for a set of inputs corresponding to the expected inputs within the framework of a specific use of the prediction algorithm considered.
the initial probability law is a uniform distribution or a Gaussian distribution.
The initial symmetry group is a Lie group, in particular the initial symmetry group is the group of the roto-translations of the plane.

The description further describes a computer program product including program instructions forming a computer program stored on a readable storage medium, wherein the computer program can be loaded on a data processing unit and implements a method for learning as described hereinabove.

The description further relates to a readable storage medium including program instructions forming a computer program, the computer program being loadable on a data processing unit and implementing a method for learning as described hereinabove when the computer program is implemented on the data processing unit.

### BRIEF DESCRIPTION OF FIGURES

The features and advantages of the invention will appear upon reading the following description, given only as an example, but not limited to, and making reference to the enclosed drawings, wherein:

FIG. 1 is a schematic representation of a system and of a computer program product, and

FIG. 2 is a schematic representation of the elements of a group and of two subgroups of the group, and

FIG. 3 is a schematic representation of the results obtained for an example of implementation of a method for learning.

### DETAILED DESCRIPTION OF PREFERRED EMBODIMENTS

### Brief Description of the System

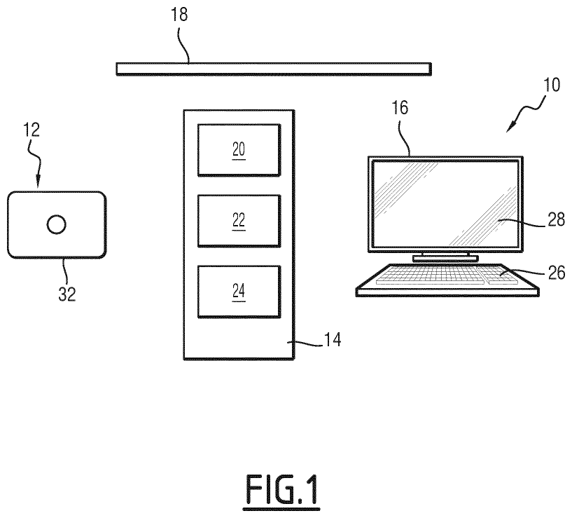

A system 10 and a computer program product 12 are shown in FIG. 1.

The interaction between the system 10 and the computer program product 12 makes it possible to implement a method for learning a prediction algorithm. Thereby, the method for learning is a method implemented by a computer.

According to the example described, it is assumed that system 10 also implements the learned prediction algorithm.

However, in many applications, the implementation system will be different from the system that implements the method for learning. As a result, specific constraints might have to be taken into account.

In each case, the implementation system, whether or not merged with the system 10, has similar features to what will now be described.

The system 10 is a desktop computer. In a variant, the system 10 is a computer mounted on a rack, a laptop, a tablet, a personal digital assistant (PDA) or a smartphone.

In specific embodiments, the computer is suitable for operating in real time and/or is in an on-board system, in particular in a vehicle such as an aircraft.

In the case shown in FIG. 1, the system 10 comprises a calculation unit 14, a user interface 16 and a communication device 18.

More generally, the computer 14 is an electronic computer suitable for handling and/or transforming data represented as electronic or physical quantities in registers of the system 10 and/or memories in other similar data corresponding to physical data in the register memories or other types of displays, transmission devices or storage devices.

As specific examples, the computing unit 14 comprises a single-core or multi-core processor (such as a central processing unit (CPU), a graphics processing unit (GPU), a microcontroller and a digital signal processor (DSP), a programmable logic circuit (such as an application specific integrated circuit (ASIC), an array of field programmable gates (FPGAs), a programmable logic device (PLD) and programmable logic arrays (PLAs), a state machine, a logic gate, and discrete hardware components.

The computing unit 14 comprises a data processing unit 20 suitable for processing data, in particular by performing calculations, memories 22 suitable for storing data and a player 24 suitable for reading a computer-readable medium.

The user interface 16 comprises an input device 26 and an output device 28.

The input device 26 is a device which allows the user of the system 10 to enter information or commands into the system 10.

In FIG. 1, the input device 26 is a keyboard. In a variant, the input device 26 is a pointing device (such as a mouse, a touchpad and a graphics tablet), a voice recognition device, an eye sensor or a haptic device (movement analysis).

The output device 28 is a graphical user interface, i.e. a display unit designed for supplying information to the user of system 10.

In FIG. 1, the output device 28 is a display screen for a visual presentation of the output. In other embodiments, the output device is a printer, an augmented and/or virtual display unit, a loud-speaker, or other sound generating device for presenting the output in an audio form, a unit producing vibrations and/or odors or a unit suitable for producing an electrical signal.

In a specific embodiment, the input device 26 and the output device 28 are the same component forming human-machine interfaces, such as an interactive display.

The communication device 18 can be used for unidirectional or bidirectional communication between the components of the system 10. The communication device 18 e.g. is a bus communication system or an input/output interface.

The presence of the communication device 18 makes it possible, in certain embodiments, that the components of the system 10 are far from each other.

According to the example shown in FIG. 1, the computer program product 12 comprises a computer-readable medium 32.

The computer-readable medium 32 is a tangible device readable by the player 24 of the computing unit 14.

In particular, the computer-readable medium 32 is not a transient signal per se, such as radio waves or other freely propagating electromagnetic waves, such as light pulses or electronic signals.

Such a computer-readable storage medium 32 is e.g. an electronic storage device, a magnetic storage device, an optical storage device, an electromagnetic storage device, a semiconductor storage device, or any combination thereof.

As a non-exhaustive list of more specific examples, the computer-readable storage medium 32 is a mechanically encoded device, such as punched cards or relief structures in a groove, a diskette, a hard disk, a read-only memory (ROM), a random-access memory (RAM), an erasable read-only memory (EROM), an electrically erasable and readable memory (EEPROM), a magneto-optical disk, a static random-access memory (SRAM), a compact disk (CD-ROM), a digital versatile disk (DVD), an USB key, a floppy disk, a flash memory, a solid state drive (SSD) or a PC card such as a PCMCIA memory card.

A computer program is stored on the computer-readable storage medium 32. The computer program includes one or a plurality of sequences of stored program instructions.

Such program instructions, when executed by the data processing unit 20, lead to the execution of steps of the method for learning.

The form of program instructions e.g. is a source code form, a computer-executable form, or any intermediate form between a source code and a computer-executable form, such as the form resulting from the conversion of the source code via an interpreter, an assembler, a compiler, a linker, or a locator. In a variant, the program instructions are a microcode, firmware instructions, state definition data, integrated circuit configuration data (e.g. VHDL), or an object code.

Program instructions are written in any combination of one or a plurality of languages, e.g. an object-oriented programming language (FORTRAN, C++, JAVA, HTML), a procedural programming language (C e.g.).

Alternatively, the program instructions are downloaded from an external source via a network, as is the case, in particular, for applications. In such case, the computer program product comprises a data carrier signal on which the program instructions are encoded.

In each case, the computer program product 12 comprises instructions which can be loaded into the data processing unit 20 and adapted for triggering the execution of the method for learning a prediction algorithm when same are executed by the data processing unit 20. According to the embodiments, the execution is entirely or partially performed either on the system 10, i.e. a single computer, or in a system distributed between a plurality of computers (in particular via the use of cloud computing).

### Goal of the Method for Learning

The operation of the system 10 is now described with reference to an example of implementation of a method for learning a prediction algorithm.

The predictive algorithm is apt to predict, for given inputs, the value of one or a plurality of outputs.

The algorithm was learned using a machine learning technique and a learning dataset.

More precisely, in the example which will be described, the algorithm is a supervised statistical learning algorithm.

Hereinafter, such an algorithm is denoted by a function ƒ: X→Y where the set X denotes the set of inputs of the algorithm and Y denotes the set of outputs of the algorithm.

The predictive algorithm is e.g. a support vector machine, a neural network or a random forest. More generally, any type of supervised predictive algorithm is conceivable for the present context.

Such a predictive algorithm can be used for very diverse contexts such as image classification, three-dimensional shape recognition or decision-making support within the context of autonomous drone control.

Preferentially, the predictive algorithm inputs and/or outputs physical quantities corresponding to measurements from one or a plurality of sensors.

As a particular example, the algorithm is an image processing algorithm, such as a pattern recognition algorithm or an image classification algorithm.

Before describing the method for learning in more detail, in order to better understand what will follow, it is interesting to introduce a number of notations and notions.

### Presentation of Notions Useful for the Rest of the Description

### Supervised Learning and the PAC Hypothesis

Let us take a set of n data (xᵢ,yᵢ), thereafter called a learning set. Such a dataset can be seen as n realizations of a random variable (X,Y) of distribution [symbol] _{X,Y}, and with values in a product space X× [symbol] , where X and [symbol] are, e.g., two subspaces R^{k}, with k a positive integer.

Hereinafter, a statistical learning algorithm (prediction algorithm) is represented by a parametric prediction function ƒ_{θ}: X→ [symbol] , where θ∈ [symbol] ^{d} represents a set of real parameters. The above corresponds e.g. to the value of the weights in a neural network with a given topology.

In the context of supervised learning, the quality of a given prediction function ƒ_{θ} is assessed against the distribution [symbol] by use of the mean risk. The mean risk [symbol] (ƒ_{θ}, X, Y) is defined as the mean evaluation of the relative I-differences i.e. as follows:

[symbol]

(ƒ_{θ},X,Y)= [symbol] [ [symbol] (ƒ_{θ}(X),Y)]

Where [symbol] is the expectation operator and the function [symbol] : [symbol] × [symbol] → [symbol] ⁺ is a given precision metric, also called a loss function.

The goal of supervised statistical learning is, given the learning set, to find a parameter θ₀∈ [symbol] ^{d} solution of the following optimization problem

$${min}_{θ ∈ {ℝ}^{d}} ℛ ( {f}_{θ} , X , Y )$$

In practice, the distribution [symbol] is unknown and cannot be easily inferred from the learning set. To overcome such difficulty, for the learning set considered, the notion of empirical risk defined as follows can be used:

$$ℛ ( {f}_{θ} , {( {x}_{i} , {y}_{i} )}_{i = 1}^{n} ) = \frac{1}{n} {\sum }_{i = 1}^{n} ℓ ( {f}_{θ} ( {x}_{i} ) , {y}_{i} )$$

It should be noted that [symbol] (ƒ_{θ},(xᵢ,yᵢ)ᵢ₌₁ⁿ) is an unbiased estimator of [symbol] (ƒ_{θ}, X, Y), as defined by the following equality:

$${lim}_{{n \to ∞}^{}} ℛ ( {f}_{θ} , {( {x}_{i} , {y}_{i} )}_{i = 1}^{n} ) = ℛ ( {f}_{θ} , X , Y )$$

The minimization of the risk [symbol] (ƒ_{θ}, (xᵢ,yᵢ)ᵢ₌₁ⁿ) thereby leads to an estimator θ₀ⁿ of the parameter θ₀, which is also convergent for n→∞. Such approach is motivated by the PAC hypothesis (referring to the term “probably approximately correct”) which states that future samples for which the algorithm will make predictions are also distributed according to distribution [symbol] _{X,Y}.

In this context, the quantity [symbol] (ƒ_{θ}_{₀}_{ⁿ}, (xᵢ,yᵢ)ᵢ₌₁ⁿ) is called a learning error and the minimization thereof thereby aims to minimize the generalization error [symbol] (ƒ_{θ}_{₀}_{ⁿ},(\tilde{x}ⱼ,\tilde{y}ⱼ)ᵢ₌₁^{N}), where (\tilde{x}ⱼ,\tilde{y}ⱼ)ᵢ₌ⱼ^{N} is a set of realizations of the random variable (X,Y) distinct from the learning set that made possible the derivation of the parameter θ₀ⁿ.

The notions of learning errors and of generalization are also generalized by considering that the learning phase is performed with respect to a distribution [symbol] ^{e} and that the learned algorithm will subsequently be used on samples according to another distribution [symbol] ^{e}.

By considering first that n→∞ and by introducing the notations

$$\{ \begin{matrix}ℛ ( {f}_{θ} , X , Y , {ℙ}^{e} ) & = {𝔼}^{e} [ ℓ ( {f}_{θ} ( X ) , Y ) ] \\ ℛ ( {f}_{θ} , X , Y , {ℙ}^{u} ) & = {𝔼}^{u} [ ℓ ( {f}_{θ} ( X ) , Y ) ]\end{matrix}$$

with E^{k} the expectation operator under the measure of probability [symbol] ^{k}, one has that the learning phase aims to find θ₀^{e}∈R^{d} such that:

$$ℛ ( {f}_{{θ}_{0}^{e}} , X , Y , {ℙ}^{e} ) = {min}_{θ ∈ {ℝ}^{d}} ℛ ( {f}_{θ} , X , Y , {ℙ}^{e} )$$

thus leading to a learning error [symbol] (ƒ_{θ}_{₀}_{^{e}}, X, Y, [symbol] ^{e}).

The generalization error is defined by [symbol] (ƒ_{θ}_{₀}_{^{e}}, X, Y, [symbol] ^{u}).

For n set, the two errors are defined from unbiased estimators of the preceding quantities.

Moreover, the usual case of the PAC hypothesis is found simply by considering the case [symbol] ^{e}= [symbol] ^{u}= [symbol] .

### Modeling Transformations

Hereinafter, transformations represented by elements of groups acting on a given set will be used.

Thereby, the rotations of the images viewed as elements of [symbol] ² will be represented by elements of the Lie group SO(2) operating on [symbol] ².

As a result therefrom, it is useful to specify the mathematical concepts derived from group theory to better understand what will follow.

First, a group is a set G, endowed with a composition law*: G×G→G that is associative and has a neutral element usually denoted by e∈G.

Moreover, each element g∈G is invertible in the group G in the sense that there is a single element denoted by g⁻¹ such that g*g⁻¹=g⁻¹*g=e.

A locally compact group (G,*) is a group with a locally compact topology such that the group law* and the inversion are continuous.

A subgroup H⊆G is a subset of the group G containing the neutral element e that is stable by the composition law* restricted to the elements of H.

Among all subgroups of the group G, there are normal subgroups that are stable by conjugation, in the sense that ∀h∈H and ∀g∈G, g⁻¹*h*g∈H.

For a closed normal subgroup H of the group G, for g∈G, all classes on the left gH are defined by the following equality:

gH={g*h,h∈H}

The set of equivalence classes forms a group as such, called the quotient group of the group G by H and denoted by G/H.

In the case where the group G is locally compact, the quotient group G/H is also compact.

When H is an arbitrary subgroup, G/H is not necessarily a group and we then speak of quotient space.

Moreover, p_{H}^{G}: G→G/H is the canonical projection associating an element of the group G to the class thereof in the quotient space G/H.

With the previous notations, the property ∀g∈G, g*p_{H}^{G}(g)⁻¹∈H is verified and the element g*p_{H}^{G}(g)⁻¹ is denoted by h_{g}.

Finally, a group G acts on a set S if there is an operator ∘: G×S→S compatible with the group law* in the sense that ∀g₁,g₂∈G, the property g₁∘(g₂∘S)=(g₁*g₂)∘S is verified.

Hereinafter, as an example, the groups are locally compact groups, the action of which on a given set S is assumed to be continuous.

### Distributions on a Group of Transformations

The present method uses transformation distributions which are represented as indicated hereinabove by group elements. It is thus useful to introduce notions relating to the theory of measure on compact groups.

Haar's Theorem states that, modulo a normalization constant, there is a unique probability measure defined on the Borelian tribe [symbol] (G) of the group G and denoted by μ, which is non-trivial, a-additive, and left-invariant in the sense that the property ∀g∈G, ∀B∈ [symbol] (G), μ(gB)=μ(g) is verified.

The Haar measure μ associates an invariant volume with the subset of the group G so that the invariant volume serves for defining an integral for functions operating on locally compact groups using Lebesgue integration theory.

A probability measure on a group G is a measure v which is non-negative, real-valued, σ-finite, and such that v(G)=1.

Thereby, the Haar measure re-normalized to 1, which is denoted by μ^{G}, defines a probability measure associated with a probability distribution [symbol] ^{G} called the uniform law on the group G.

It should be noted that the method applies for other distributions [symbol] ^{G} on a given group G. As an example, however, the following description is restricted to the case of distributions represented by absolutely continuous measures v^{G} with respect to the Haar measure in the sense that there is a density function pᵥ_{^{G}} such that the following condition is satisfied:

v^{G}(S)=∫_{S}pᵥ_{^{G}}(g)dμ^{G}∀S∈ [symbol] (G)

### Notion of Invariance

Hereinafter, it is assumed that the random variable (X,Y) has properties of symmetries corresponding to an invariance with respect to a given G.

For example, in the case of classifying an image x∈ [symbol] ², it can be assumed that the label y is the same for the samples x_{θ}=R_{θ}*x, for θ∈[0,2π], where R_{θ}∈SO(2) denotes the rotation f angle θ in the plane [symbol] ².

In fact, if it is a question of whether or not the image represents a given animal, the fact that the image has rotated does not change the fact whether the image includes the given animal or not. In such particular example, the labeling is invariant by a rotation of angle θ in the plane [symbol] ².

For the following, a random variable is introduced g on the group G of distribution v^{G}, [symbol] ^{G} the probability distribution associated with the random variable (X, Y, g) and d [symbol] ^{G} the associated measure.

One then has:

$$\begin{matrix}d {ℙ}^{G} ( x , y , g ) = d {ℙ}^{G} ( x , y \vert g ) {v}^{G} ( g ) \\ = d {ℙ}^{G} ( y \vert g , x ) ( d {ℙ}^{G} ( x \vert g ) {v}^{G} ( g )\end{matrix}$$

Due to modeling by group action, the random variables X and g can be considered to be independent.

Similarly, the symmetries mentioned hereinabove result in a conditional invariance property of the random variable Y with respect to the random variable g.

For the preceding equation, the above translates mathematically into the following equations:

$$\begin{matrix}d {ℙ}^{G} ( x , y , g ) = d {ℙ}^{G} ( y \vert x ) d {ℙ}^{G} ( x ) {v}^{G} ( g ) \\ = d ℙ ( x , y ) {v}^{G} ( g ) \\ = ( d ℙ ⊗ {v}^{G} ) ( x , y , g )\end{matrix}$$

where [symbol] is the marginal distribution of (X,Y) and d [symbol] ⊗v^{G} is the product measure of d [symbol] and v^{G}.

### Data Augmentation

The present paragraph aims to explain what a learning data augmentation technique is, more simply referred to, hereinafter, as data augmentation technique.

To this end, the following hypotheses are made: the learning is supervised learning and the learning set considered satisfies a symmetry property corresponding to a conditional invariance to the action of a group G as described hereinabove.

The purpose of a data augmentation technique is to improve the performance and robustness of a supervised statistical learning algorithm.

The data augmentation technique consists in adding to the initial learning set, samples of the form (g∘xᵢ,yᵢ)ᵢ₌₁ⁿ for g∈G distributed according to the distribution associated with the measure v^{G}.

In such context, the learning phase corresponding to a prediction function ƒ_{θ} aims to minimize an empirical risk taking into account a weighting by the probability measure v^{G} and serves for the calculation of an estimator θ_{0,G}ⁿ which is a solution to the following minimization problem:

$${min}_{θ} ℛ ( {{f}_{θ} ( ℊ ∘ {x}_{i} , {y}_{i} )}_{i = 1}^{n} , {ℙ}^{G} ) = {min}_{θ} {\int }_{G} \{ \frac{1}{n} {\sum }_{i = 1}^{n} ℓ ( {f}_{θ} ( g ∘ {x}_{i} ) , {y}_{i} ) \} {v}^{G} ( g )$$

In practice, the data augmentation technique can be implemented differently and more particularly, integrated into a stochastic gradient descent.

More precisely, the update rule for the parameter θ_{0,G}^{n,t} is give in such case by the following formula,

$${θ}_{0 , G}^{n , t + 1} = {θ}_{0 , G}^{n , t} - \frac{{λ}_{t}}{{B}_{t}} {\sum }_{i ∈ {B}_{t}} ∇ ℓ ( {f}_{θ} ( {g}_{i , t} ∘ {x}_{i} ) , {y}_{i} )$$

where λₜ∈ [symbol] ⁺ is the learning rate, Bₜ the set of indices considered for the estimation of the gradient (minibatch) and where they g_{i,t}∈G correspond to realizations of the random variable g.

Considering n→∞, one then has that the two implementations envisaged aim to minimize the following functional:

$$\begin{matrix}{lim}_{n \to ∞} ℛ ( {f}_{θ} , {( ℊ ∘ {x}_{i} , {y}_{i} )}_{i = 1}^{n} , {ℙ}^{G} ) = {𝔼}^{G} [ ℓ ( {f}_{θ} ( ℊ ∘ X ) , Y ) ] \\ = ℛ ( {f}_{θ} , ℊ ∘ X , Y , {ℙ}^{G} )\end{matrix}$$

with [symbol] ^{G} the expectation operator under the measure [symbol] ^{G}.

### Description of an Example of a Method for Learning

In the present example, the method for learning includes a first reception step, a second reception step, a determination step, a generation step and an implementation step for a learning.

During the first reception step, the system 10 receives a current learning dataset.

As will be subsequently illustrated, the current learning dataset depends on how the implementation step of the learning is actually carried out.

During the second reception step, the system 10 receives at least one invariance property of the prediction of the prediction algorithm to be learned with respect to the inputs that the prediction algorithm can take as input according to a symmetry group G.

Such a symmetry group G is called an initial symmetry group G.

As an example, the initial symmetry group G is a Lie group, in particular the initial symmetry group G is the group of the roto-translations of the plane.

The initial symmetry group G is endowed with a probability law v^{G}, the probability law is called the initial probability law v^{G}.

As an example, the initial probability law v^{G} is a uniform distribution or a Gaussian distribution.

According to the example described, the initial probability law v^{G} is obtained from the likelihood of the transformations associated with the initial symmetry group G measured for a set of inputs corresponding to the expected inputs within the framework of a specific use of the prediction algorithm considered.

According to another example, the initial probability law v^{G} can be obtained from expert knowledge with regard to the properties to be satisfied by the prediction algorithm considered.

During the determination step, the system 10 determines a subgroup H of the initial symmetry group G.

The subgroup H is provided with a probability law, called the subgroup probability law P^{H}.

The subgroup H also has a dimension (a size when same is finite)

The subgroup H corresponds to transformations of the inputs given to the prediction algorithm.

Furthermore, the subgroup H is intended to be used for generating learning data by applying the corresponding transformations to the initial learning dataset according to the subgroup probability law [symbol] ^{H}.

The use of a sub-group H makes it possible herein to guarantee the existence of a solution. Such would not be the case if a random selection of data from the initial symmetry group G were made.

The system 10 determines the subgroup H and the subgroup probability law [symbol] ^{H} according to an optimization technique under at least one optimization constraint.

The optimization technique uses the initial learning dataset, the initial symmetry group G, and the initial probability law [symbol] ^{G}.

Advantageously, a plurality of optimization constraints are taken into account in the optimization technique.

Each optimization constraint is the mathematical form of at least one constraint on the practical implementation of the learning or learning constraint, as well as on the deployment of the learned algorithm on a target architecture.

According to a first example, since the system on which the learned algorithm is deployed (possibly merged with the system 10) is a physical system, the capacities thereof are limited, in particular in terms of memory and of quantity of operations that can be performed in a given time.

In this sense, the constraints to be taken into account during the learning of the first example are exogenous since the constraints are related to the hardware capabilities of the deployment architecture.

Examples of such learning constraints include the storage capacity, the quantity of calculation achievable by the system on which the learned algorithm is deployed, the desired response time or constraints related to data confidentiality or to security.

According to a second example, the data augmentation method results in practice in an increase in the learning time and/or a deterioration in the convergence of the learning process. Thereby, the time required for learning and to the convergence of learning can be relevant constraints.

Examples of conversions of such learning constraints into optimization constraints that can be used for the optimization technique are given in the example section.

In particular, at least one predetermined learning constraint is chosen from the list consisting of the memory fingerprint of the learned algorithm, the execution time of the learned algorithm on a predetermined system, the amount of calculation which can be done on a predetermined system on which the learned algorithm is intended to be used, a confidentiality constraint of certain data, a security constraint, the degree of robustness of the algorithm trained to modifications of the inputs and the learning time of the prediction algorithm.

It should be noted that learning constraints are predetermined.

According to one example, the learning constraints are provided during a supply step.

According to another example, the optimization constraints derived from the learning conditions are known and simply used in the formulation of the optimization technique.

A plurality of techniques that can be used in combination are conceivable for the optimization technique.

In general, the optimization technique consists in minimizing under constraints the difference in theoretical prediction error between a first prediction algorithm and a second prediction algorithm.

The first prediction algorithm is obtained using learning data comprising data generated from the initial symmetry group G and from the initial probability law [symbol] ^{G}.

The second prediction algorithm is [obtained] using learning data comprising data generated from the determined subgroup H and from the subgroup probability law [symbol] ^{H} and not the initial probability law [symbol] ^{G} like the first algorithm.

According to a first example, the optimization technique is an optimization of a quadratic target function under quadratic constraints.

According to a second example, the optimization technique uses a constraint that is a limitation of at least one moment of the subgroup probability law [symbol] ^{H} with a bound.

More particularly, the bound is an upper bound on the variance of the subgroup probability distribution H.

In a variant, the previous constraint can be replaced by the use of an upper bound on the size (or the dimension) of the subgroup H.

The system 10 thereby obtains a subgroup H of the initial symmetry group G.

During the generation step, the system 10 generates data using the determined subgroup H, the subgroup probability law [symbol] ^{H}, and the set of the current learning dataset.

The system 10 thereby obtains generated data.

During the step of implementing a learning, the system 10 learns the prediction algorithm by implementing a learning using the generated data.

According to a first example, the learning uses an iterative data generation technique.

In such an example, each iteration comprises the generation step.

The implementation step is performed with only the generated data.

In such example, the current learning dataset used is the dataset generated at the current iteration.

The first example corresponds to a learning of the algorithm by generating data on the fly at each iteration of the gradient descent. System 10 uses the generation step for such purpose at each iteration, without any dependence on the preceding iteration. The expression “stochastic gradient descent” is sometimes used.

According to a second example, the learning uses a dataset formed by all the data generated and an initial dataset.

In such an example, the initial dataset is used as the current learning dataset.

### Justifications for the Proper Functioning of the Described Method

Hereinafter, the method that has just been described is interpreted mathematically.

It is interesting to observe first that for a given learning with symmetry properties, which is represented by the given group G endowed with a probability law v^{G} characterizing the intended robustness, it is not always possible to implement the data augmentation strategy presented hereinabove, mainly due to calculation and storage time conslearnts.

First of all, the increase in the learning set leads to an increase in learning time and convergence problems can then arise.

Moreover, in order to be able to capture adequately the information brought by the augmented dataset, the capacity of the learning algorithm should be increased in order to avoid under-learning phenomena, such dimension also leading to an increase in the learning time, the inference execution time, as well as of the memory fingerprint of the algorithm.

Thereby, in order to be able to be adapted to operational constraints, it could be judicious in practice to have a reduced increase strategy, which corresponds to the use of a subgroup H of the group G, as defined in the previous paragraph, and of a distribution v^{H} on the group.

For example, if G=SE(2) is the group of isometries of the plane and v^{G} the uniform distribution on the group, a reduced strategy might be to consider a uniform sampling of H=SO(2), i.e. to increase the data only by applications of rotations.

In such context, it is necessary to choose the subgroup H (and its associated probability law) in an intelligent way, this choice should make it possible in particular to reduce the bias introduced by the use of a subgroup H instead of the group G.

Also, in a first step, it is useful to mathematically calculate the bias introduced by the use of a subgroup H instead of the group G.

Furthermore, the hypothesis n→∞ is also made, which, as explained hereinabove, does not imply a loss of generality.

Indeed, in such a case, the PAC hypothesis is not satisfied since only the following equalities [symbol] ^{e}= [symbol] ^{H} and [symbol] ^{u}= [symbol] ^{G} are considered to be true.

Thereby, it is studied a prediction function algorithm ƒ_{θ}_{_{0,H}} that has been learned and such that:

$$ℛ ( {f}_{{θ}_{0 , H}} , 𝒽 ∘ X , Y , {ℙ}^{H} ) = {min ℛ}_{θ} ( {f}_{θ} , 𝒽 ∘ X , Y , {ℙ}^{H} )$$

with [symbol] a random variable with values in the subgroup H and associated with the probability measure v^{H}, and [symbol] (ƒ_{θ}_{_{0,H}}, [symbol] ∘X, Y, [symbol] ^{H}) the learning error obtained.

The associated generalization error is given by [symbol] (ƒ_{θ}_{_{0,H}}, g∘X, Y, [symbol] ^{G}).

The quantity [symbol] (ƒ_{θ}_{_{0,H}}, g∘X, Y, [symbol] ^{G}) can be rewritten as follows:

$$\begin{matrix}R ( {f}_{{θ}_{0 , H}} , ℊ ∘ X , Y , {ℙ}^{G} ) = {𝔼}^{G} [ ℓ ( {f}_{{θ}_{0 , H}} ( ℊ ∘ X ) , Y ) ] \\ = {\int }_{G} {\int }_{x \times y} ℓ ( {f}_{{θ}_{0 , H}} ( g ∘ x ) , y ) ( d ℙ ⊗ {v}^{G} ) ( x , y , g ) \\ = {\int }_{G} ℛ ( {f}_{{θ}_{0 , H}} , g ∘ X , Y , ℙ ) {v}^{G} ( g )\end{matrix}$$

Similarly, one has:

[symbol]

(ƒ_{θ}_{_{0,H}}, [symbol] ∘X,Y, [symbol] ^{H})=∫_{H} [symbol] (ƒ_{θ}_{_{0,H}},h∘X,Y, [symbol] )v^{H}(h)

In order not to overload the notations, θ=θ_{0,H} is used in the following development.

Evaluating the bias introduced by the use of the subgroup H is equivalent to comparing the above learning and generalization errors by defining Δ_{H}^{G}(ƒ_{θ}) as follows:

$${Δ}_{H}^{G} ( {f}_{θ} ) = ℛ ( {f}_{θ} , 𝔤 ∘ X , Y , {ℙ}^{G} ) - ℛ ( {f}_{θ} , 𝔥 ∘ X , Y , {ℙ}^{H} )$$

One then has:

$$\begin{matrix}{Δ}_{H}^{G} ( {f}_{θ} ) = {\int }_{G} ℛ ( {f}_{θ} , g ∘ X , Y , ℙ ) {v}^{G} ( g ) - {\int }_{H} ℛ ( {f}_{θ} , h ∘ X , Y , ℙ ) {v}^{H} ( h ) \\ = {\int }_{G} \{ ℛ ( {f}_{θ} , g ∘ X , Y , ℙ ) - ℛ ( {f}_{θ} , {h}_{g} ∘ X , Y , ℙ ) \} {v}^{G} ( g ) + \\ {\int }_{G} ℛ ( {f}_{θ} , {h}_{g} ∘ X , Y , ℙ ) {v}^{G} ( g ) - {\int }_{H} ℛ ( {f}_{θ} , h ∘ X , Y , ℙ ) {v}^{H} ( h ) \\ = {Δ}_{{H}_{G}}^{G} ( {f}_{θ} ) + {Δ}_{H}^{{H}_{G}} ( {f}_{θ} )\end{matrix}$$

where the quantities Δ_{H}_{_{G}}^{G}(ƒ_{θ}) and Δ_{H}^{H}^{_{G}}(ƒ_{θ}) are defined as:

$$\begin{matrix}{Δ}_{{H}_{G}}^{G} ( {f}_{θ} ) = {\int }_{G} \{ ℛ ( {f}_{θ} , g ∘ X , Y , ℙ ) - ℛ ( {f}_{θ} , {h}_{g} ∘ X , Y , ℙ ) \} {v}^{G} ( g ) \\ {Δ}_{H}^{{H}_{G}} ( {f}_{θ} ) = {\int }_{G} ℛ ( {f}_{θ} , {h}_{g} ∘ X , Y , ℙ ) {v}^{G} ( g ) - {\int }_{H} ℛ ( {f}_{θ} , h ∘ X , Y , ℙ ) {v}^{H} ( h )\end{matrix}$$

With the present mathematical formulation, the intelligent choice of subgroup H and of the measure of subgroup v^{H} is to minimize the risk of error caused by the under-augmentation.

More precisely, it is appropriate to choose the subgroup H and the measure of the subgroup v^{H} by minimizing |Δ_{H}^{G}(ƒ_{θ})|, while satisfying the set of operation constraints. More formally, the above amounts to solving the following optimization problem:

$${min}_{{H ⊆ G , {v}^{H}}_{C ( {f}_{θ} ) \leq {C}_{0}}} \vert {Δ}_{H}^{G} ( {f}_{θ} ) \vert$$

where C(ƒ_{θ}) is a vector function associating a plurality of performance indicators with the prediction function ƒ_{θ}, such as e.g. the learning and inference times, or else the memory footprint of the corresponding learned algorithm, and C₀ a vector of associated values representing the operational constraints considered.

Since the inequality |Δ_{H}^{G}(ƒ_{θ})|≤|Δ_{H}_{_{G}}^{G}(ƒ_{θ})|+|Δ_{H}^{H}^{_{G}}(ƒ_{θ})| is verified, it is interesting to focus on minimizing both the term |Δ_{H}_{_{G}}^{G}(ƒ_{θ})| and the term |Δ_{H}^{H}^{_{G}}(ƒ_{θ})|.

For the first term, it is possible to derive the following formulas:

$$\begin{matrix}\vert {Δ}_{{H}_{G}}^{G} ( {f}_{θ} ) \vert \leq {\int }_{G} \vert R ( {f}_{θ} , g ∘ X , Y , ℙ ) - ℛ ( {f}_{θ} , {h}_{g} ∘ X , Y , ℙ ) \vert {v}^{G} ( g ) \\ \leq {\int }_{G} {\int }_{x \times y} \vert ℓ ( {f}_{θ} ( g ∘ x ) , y ) - ℓ ( {f}_{θ} ( {h}_{g} ∘ x ) , y ) \vert d ℙ ( x , y ) {v}^{G} ( g )\end{matrix}$$

Assuming first that the prediction function ƒ_{θ} and [symbol] are continuous, the following inequality is obtained:

$$\vert ℓ ( {f}_{θ} ( g ∘ x ) , y ) - ℓ ( {f}_{θ} ( {h}_{g} ∘ x ) , y ) \vert \leq {M}_{y} {‖ g ∘ x - {h}_{g} ∘ x ‖}_{x}$$

where ∥ ∥ₓ is a norm over the space X.

Using the continuity of the group action and the fact that h_{g}=g*p_{H}^{G}(g)⁻¹, one has:

$$\begin{matrix}\vert ℓ ( {f}_{θ} ( g ∘ x ) , y ) - ℓ ( {f}_{θ} ( {h}_{g} ∘ x ) , y ) \vert \leq {M}_{y} {‖ g ‖}_{G} {‖ e - {{p}_{H}^{G} ( g )}^{- 1} ‖}_{G / H} {‖ x ‖}_{x} \\ \leq {M}_{y , x , G} {‖ e - {{p}_{H}^{G} ( g )}^{- 1} ‖}_{G / H}\end{matrix}$$

with M_{y} and M_{y,x,G} constants independent of the subgroup H.

### Thereby:

$$\vert {Δ}_{{H}_{G}}^{G} ( {f}_{θ} ) \vert \leq {\int }_{x \times y} {M}_{y , x , G} \{ {\int }_{G} {‖ e - {{p}_{H}^{G} ( g )}^{- 1} ‖}_{G / H} {v}^{G} ( g ) \} d ℙ ( x , y )$$

so that the preceding problem amounts to the minimization of the term ∫_{G}∥e−p_{H}^{G}(g)⁻¹∥_{G/H}v^{G}(g), which thus amounts to seeking to minimize the action of the elements of the quotient space G/H, weighted by the measure v^{G}.

In the trivial case where H=G, the quotient space satisfies G/H={e} and the term is zero.

Such reasoning can be extended by relaxing the continuity constraints in order to cover more particularly the classification case for which [symbol] ^{cl}(y,z)=1_{(y≠z)}. Specifically, one has herein:

$$\vert ℓ ( {f}_{θ} ( g ∘ x ) , y ) - ℓ ( {f}_{θ} ( {h}_{g} ∘ x ) , y ) \vert = {1}_{\{ {f}_{θ} ( g ∘ x ) \neq {f}_{θ} ( {h}_{g} ∘ x ) \}}$$

It is possible to fall back on the preceding case by assuming a continuity to the right of the prediction function ƒ_{θ} and by applying the above reasoning to each of the continuity segments.

From the point of view of the group actions considered, the two terms which define Δ_{H}^{H}^{_{G}}(ƒ_{θ}) involve only the elements h_{g} and h, which are elements of the subgroup H.

In order to simplify the expression of the difference, it is possible to write the first term as an integral on the subgroup H:

$${\int }_{G} ℛ ( {f}_{θ} , {h}_{g} ∘ X , Y , ℙ ) {v}^{G} ( g ) - {\int }_{H} ℛ ( {f}_{θ} , h ∘ X , Y , ℙ ) {v}^{G} ( {G}_{h} )$$

with Gₕ={g∈G/g*p_{H}^{G}(g)⁻¹=h}∈ [symbol] (G).

The inequality used hereinabove thereby becomes:

$$\vert {Δ}_{{H}_{}}^{{H}_{G}} ( {f}_{θ} ) \vert \leq {\int }_{H} ℛ ( {f}_{θ} , h ∘ X , Y , ℙ ) \vert {v}^{G} ( {G}_{h} ) - {v}^{H} ( h ) \vert$$

The expression shows that in the absence of any particular constraint on the choice of a given subgroup H, the term can be canceled by choosing the measure of the subgroup v^{H} in an appropriate way. The appropriate way is to verify the following condition:

$${v}^{H} ( h ) = {v}^{G} ( \{ g ∈ G / g ⋆ {{p}_{H}^{G} ( g )}^{- 1} = h \} ) ∀ h ∈ H$$

It should be noted, however, that the constraints represented by C₀ can contain restrictions on the form of the measure of the subgroup v^{H}, such as e.g. a limit in terms of variance for convergence reasons.

Thereby, an intelligent choice of the subgroup H and of the measure of the subgroup v^{H} is to optimally solve the following condition:

$${min}_{{H ⊆ G , {v}^{H}}_{C ( {f}_{θ} ) \leq {C}_{0}}} {\int }_{G} {‖ e - {{p}_{H}^{G} ( g )}^{- 1} ‖}_{G / H}^{2} {v}^{G} ( g ) + {\int }_{H} {\vert {v}^{G} ( {G}_{h} ) - {v}^{H} ( h ) \vert}^{2}$$

The quadratic norms used in the preceding equation are indicative and can be replaced, in practice, by other norms.

Depending on the form of G and the subgroups thereof, if any, different optimization techniques can be considered.

Hence the fact that a plurality of optimization techniques are used.

Furthermore, as indicated hereinabove, the intelligent choice makes it possible to use parametric shapes [symbol] , which makes possible the use of a conventional gradient descent.

### Advantages of the Method for Learning

In each case, the method for learning is a method equipped with data under-augmentation for learning supervised statistical learning algorithms. The method for learning is based on the use of a data augmentation technique consisting in adding samples to the initial learning set in order to improve the precision and the robustness of the prediction algorithm to be learned.

Otherwise formulated, the present method can be used for the calculation of a data under-augmentation strategy aimed at maximizing the robustness of a supervised statistical learning algorithm with respect to a given group of symmetries, within the framework of satisfying with operational constraints set beforehand.

In the method described, a data augmentation strategy compatible with the operational dimension of the use of prediction algorithms, is proposed.

For this purpose, the method uses a formalism derived from group theory. Within such framework, the method uses the notions of subgroups and distributions on the sets in order to build, through the resolution of a problem of optimization under conslearnts, a data under-augmentation strategy so as to obtain a compromise between the incorporation of symmetries within an algorithm and the different operational constraints associated with the intended application.

Otherwise formulated, the method makes it possible to implement a data augmentation technique involving a certain number of algorithmic prerequisites (learning capacity of the envisaged algorithm, number of iterations in the optimization) by determining and intelligently reducing same to make same compatible with the exogenous constraints associated with a given operational application (such as the memory footprint of the learned algorithm or the calculation time).

The proposed method leads to a simple formalization of the problem considered and the resolution thereof then becomes easily achievable by the usual numerical optimization tools.

Finally, because the method is apt to manage operational constraints, the method for learning is a method for learning a prediction algorithm apt to be implemented by a real system on a dataset of small size.

### Example: Case of Rotational Symmetry

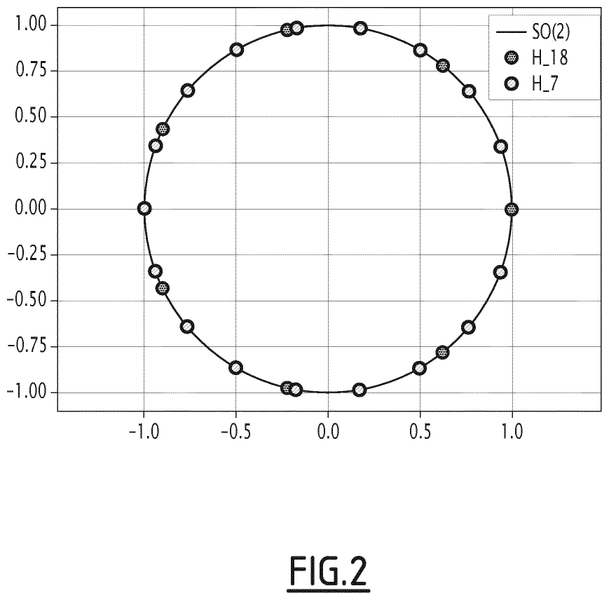

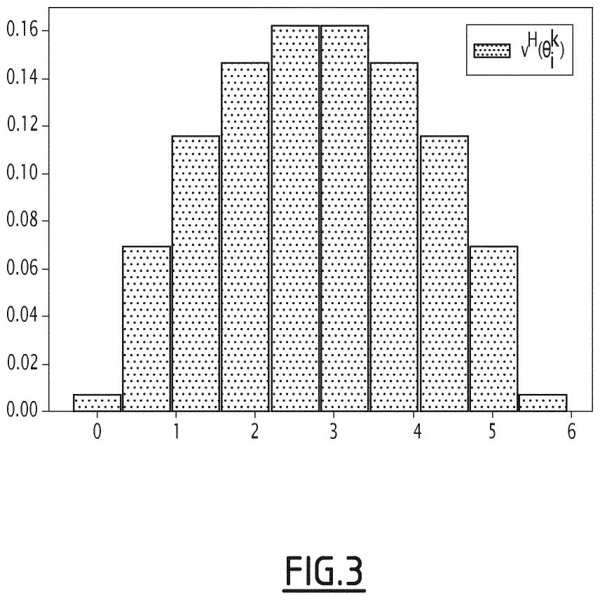

An example implemented by the Applicant is now described with reference to FIGS. 2 and 3.

In order to illustrate the preceding method for learning, a rotational symmetry group is chosen, which is more particularly involved in image classification issues.

In such context, the goal is to build a prediction algorithm ƒ_{θ} robust to rotations of the inputs thereof.

It is assumed that uniform robustness is sought. More precisely, it is appropriate to make the prediction algorithm robust to random rotations of the inputs thereof, the angles of the rotations being distributed uniformly over [0,2π].

Thereby, the group G is the group of the plane rotations, denoted by SO(2), which can be represented by the matrix group shown below,

$$SO ( 2 ) = ( \{ R ( θ ) ; θ ∈ [ 0 , 2 π ] \} , * )$$

where the group law* corresponds to the matrix multiplication and R(θ)∈ [symbol] ^{2×2} is the rotation matrix of angle θ given by:

$$R ( θ ) = [ \begin{matrix}cos θ & - sin θ \\ sin θ & cos θ\end{matrix} ]$$

For the example implemented, the following subgroups Hₖ, are considered:

$${H}_{k} = ( \{ R ( θ ) ; θ ∈ {\{ i \frac{2 π}{k} \}}_{i = 0}^{k - 1} \} , * )$$

and the corresponding quotient groups

$$SO ( 2 ) / {H}_{k} = ( \{ R ( {[ θ ]}_{\frac{2 π}{k}} ) ; θ ∈ [ 0 , 2 π ] \} , * )$$

where [·]_{y} is the modulo operator y and k is a natural integer other than 0.

FIG. 2 provides a representation of examples of subgroups Hₖ as defined hereinabove.

In the figure, the circle corresponds to all of the elements of the group of rotations plane denoted by SO(2), the pointed points correspond to all of the elements of the subgroup H₁₈ and the hatched points correspond to all of elements of the subgroup H₇.

As can be seen in FIG. 2, assuming a uniform distribution over the subgroup G, the Lebesgue measure is a measure over the unit circle, i.e. v^{G}=dθ.

By reasoning in terms of angles, it is possible to write, for

$${h}_{k}^{i} = R ( i \frac{2 π}{k} ) ∈ {H}_{k} ,$$

the following mathematical expression:

$${G}_{{h}_{k}^{i}} = \{ θ ∈ [ 0 , 2 π ] / θ - {[ θ ]}_{\frac{2 π}{k}} = i \frac{2 π}{k} \}$$

With regard to the measurement of the sub-group, one has:

$$\begin{matrix}{v}^{G} ( {G}_{{h}_{k}^{i}} ) = \frac{1}{2 π} {\int }_{0}^{2 π} {1}_{\{ θ - {[ θ ]}_{\frac{2 π}{k}} = i \frac{2 π}{k} \}} d θ \\ = \frac{1}{2 π} {\int }_{i \frac{2 π}{k}}^{( i + 1 ) \frac{2 π}{k}} d θ \\ = \frac{1}{k}\end{matrix}$$

From an operational point of view, in the present example, the Applicant assumed that two constraints were to be met.

According to a first constraint, the size of the augmentation set is constrained. The above results into the existence of an upper bound K₀ for the cardinality (size) of the subgroups Hₖ.

According to a second constraint, the convergence should be sufficiently fast. It is possible to express such constraint as an upper bound Σ₀ for the variance [symbol] (v^{H}^{ₖ}) of the distribution associated with the measure v^{H}^{ₖ} to be determined.

Thereby, in the present particular example, the quantity

$${min}_{\begin{matrix}H ⊆ G , {v}^{H} \\ C ( {f}_{θ} ) \leq {C}_{0}\end{matrix}} {\int }_{G} {‖ e - {{p}_{H}^{G} ( g )}^{- 1} ‖}_{G / H}^{2} {v}^{G} ( g ) + {\int }_{H} {\vert {v}^{G} ( {G}_{h} ) - {v}^{H} ( h ) \vert}^{2}$$

to be optimized is written as follows:

$${min}_{\begin{matrix}1 \leq k \leq {K}_{0} , {v}^{H} k \\ 𝕍 ( {v}^{H} k ) \leq {\sum }_{0}\end{matrix}} \frac{1}{2 π} {\int }_{0}^{2 π} {\vert {[ θ ]}_{\frac{2 π}{k}} \vert}^{2} d θ + {\sum }_{i = 0}^{k - 1} {\vert \frac{1}{k} - {v}^{{H}_{k}} ( {h}_{k}^{i} ) \vert}^{2}$$

Moreover, it is possible to determine the value of the integral

$$\frac{1}{2 π} {\int }_{0}^{2 π} {\vert {[ θ ]}_{\frac{2 π}{k}} \vert}^{2}$$

according to the following calculation:

$$\begin{matrix}\frac{1}{2 π} {\int }_{0}^{2 π} {\vert {[ θ ]}_{\frac{2 π}{k}} \vert}^{2} d θ = \frac{1}{2 π} \times k \times {\int }_{0}^{\frac{2 π}{k}} {θ}^{2} d θ \\ = \frac{4}{3} \frac{{π}^{2}}{{k}^{2}}\end{matrix}$$

The expression to be optimized thereby becomes:

$${min}_{\begin{matrix}1 \leq k \leq {K}_{0} , {v}^{H} k \\ 𝕍 ( {v}^{H} k ) \leq {\sum }_{0}\end{matrix}} \frac{4}{3} \frac{{π}^{2}}{{k}^{2}} + {\sum }_{i = 0}^{k - 1} {\vert \frac{1}{k} - {v}^{{H}_{k}} ( {h}_{k}^{i} ) \vert}^{2}$$

Moreover, by denoting by pᵢ^{k}=v^{H}^{ₖ}(hₖⁱ) and

$${θ}_{i}^{k} = i \frac{2 π}{k} ,$$

one has:

$$𝕍 ( {v}^{H} k ) = {\sum }_{i = 0}^{k - 1} {( {θ}_{i}^{k} )}^{2} {p}_{i}^{k} - {\sum }_{i = 0}^{k - 1} {\sum }_{j = 0}^{k - 1} {θ}_{i}^{k} {θ}_{j}^{k} {p}_{i}^{k} {p}_{j}^{k}$$

where V is the variance operator.

With such notations, the expression to be optimized then becomes:

$${min}_{\begin{matrix}1 \leq k \leq {K}_{0} , {( {p}_{i}^{k} )}_{i = 0}^{k - 1} \\ {\sum }_{i = 0}^{k - 1} {( {θ}_{i}^{k} )}^{2} {p}_{i}^{k} - {\sum }_{i = 0}^{k - 1} {\sum }_{j = 0}^{k - 1} {θ}_{i}^{k} {θ}_{j}^{k} {p}_{i}^{k} {p}_{j}^{k} \leq {\sum }_{0} \\ {\sum }_{i = 0}^{k - 1} {p}_{i}^{k} = 1 \\ 0 \leq {p}_{i}^{k} \leq 1\end{matrix}} \frac{4}{3} \frac{{π}^{2}}{{k}^{2}} + {\sum }_{i = 0}^{k - 1} {\vert \frac{1}{k} - {p}_{i}^{k} \vert}^{2}$$

The expression shows that it is necessary to solve the different problems below for k∈{1, . . . , K₀}, K₀ being the upper bound on the size of the subgroup considered, and to keep the solution used for reaching the minimum value of the target function:

$${min}_{\begin{matrix}{( {p}_{i}^{k} )}_{i = 0}^{k - 1} \\ {\sum }_{i = 0}^{k - 1} {( {θ}_{i}^{k} )}^{2} {p}_{i}^{k} - {\sum }_{i = 0}^{k - 1} {\sum }_{j = 0}^{k - 1} {θ}_{i}^{k} {θ}_{j}^{k} {p}_{i}^{k} {p}_{j}^{k} \leq {\sum }_{0} \\ {\sum }_{i = 0}^{k - 1} {p}_{i}^{k} = 1 \\ 0 \leq {p}_{i}^{k} \leq 1\end{matrix}} \frac{4}{3} \frac{{π}^{2}}{{k}^{2}} + {\sum }_{i = 0}^{k - 1} {\vert \frac{1}{k} - {p}_{i}^{k} \vert}^{2}$$

For k∈{1, . . . , K₀}, the preceding problems are nonlinear problems, the target function and constraints of which are quadratic, and can be solved via numerical optimization techniques such as quadratic optimization.

FIG. 3 shows the distribution v^{H}^{ₖ} obtained for

$${\sum }_{0} = 0.9 * \frac{{π}^{2}}{3} ,$$

for K₀=10 by solving the preceding problems.

For the case considered, the optimum solution is obtained for k=K₀, as expected, and a deviation from the uniform distribution is observed because of the different stresses considered, which was also expected.

The solution obtained is thereby a solution making it possible to obtain a good convergence and a size of the subgroup compatible with the computational capacities of the system 10 while providing a relatively good uniform robustness.

As a result, good learning of the prediction algorithm is obtained.

It should be noted that a few seconds of numerical computation were sufficient to obtain the example of rotational symmetry modeled as a quadratic optimization problem under quadratic constraints.

The method for learning thereby serves for building a data augmentation technique compatible with exogenous operational constraints, such as e.g. the memory footprint of the learned algorithm, the execution time thereof on the targeted architecture or the degree of robustness thereof to modifications of the inputs and to use the data augmentation technique for learning prediction algorithms by a machine learning technique.

Furthermore, the method for learning is compatible with any type of learning or use thereof and is particularly suitable for the design and learning of algorithms integrated in embedded systems, for which a number of operational constraints have to be taken into account from the algorithmic design phase.

Finally, it will be clearly understood that the order of the steps in the method for learning which has just been described can be different and, in particular, that certain steps can be carried out simultaneously.

More generally, any technically possible combination of the preceding embodiments making it possible to obtain a method for learning a prediction algorithm, is envisaged.

1. A method for learning a prediction algorithm, the prediction algorithm predicting for given inputs, the value of one or a plurality of outputs, the learning being implemented by computer by using a machine learning technique, the method for learning comprising:
reception of a current learning dataset;
reception of at least one invariance property of the prediction algorithm to be learned with respect to the inputs that the prediction algorithm can take as input according to a symmetry group, called an initial symmetry group, said symmetry group being provided with an initial probability law;
determination of a subgroup of the initial symmetry group, the subgroup being provided with a probability law, called the subgroup probability law, the subgroup corresponding to transformations of the inputs given to the prediction algorithm, the subgroup being intended to be used for generating learning data by applying the corresponding transformations to the current learning dataset according to the subgroup probability law, the subgroup and the subgroup probability law being determined according to an optimization technique under at least one optimization constraint, the optimization technique using the initial learning dataset, the initial symmetry group and the initial probability law, the at least one optimization constraint being derived from at least one predetermined learning constraint;
generation of data using the determined subgroup, the subgroup probability law and the entire current learning dataset, for obtaining generated data; and
implementation of a learning of the prediction algorithm using the generated data, the learning comprising:
either a learning using an iterative data generation technique, each iteration comprising said generation, the implementation being carried out with only the generated data, the current learning dataset used then being the dataset generated at the current iteration; or
a learning using a dataset formed by the dataset generated and an initial dataset, the initial dataset being used as the current learning dataset.

2. The method according to claim 1, wherein the input(s) and/or output(s) are physical quantities corresponding to measurements coming from one or a plurality of sensors.

3. The method according to claim 1, wherein the prediction algorithm comprises an image processing algorithm.

4. The method according to claim 3, wherein the prediction algorithm comprises a pattern recognition algorithm or an image classification algorithm.

5. The method according to claim 1, wherein the at least one predetermined learning constraint is chosen from the list consisting of:
a memory fingerprint of the learned algorithm;
an execution time of the algorithm learned on a predetermined system;
an amount of calculation which can be done on a predetermined system on which the learned algorithm is intended to be used;
a constraint of confidentiality of certain data;
a security constraint, the degree of robustness of the learned algorithm to changes of inputs; and
a learning time of the prediction algorithm.

6. The method according to claim 5, wherein the at least one predetermined learning constraint is the learning time of the prediction algorithm.

7. The method according to claim 1, wherein the optimization technique comprises minimizing, under optimization constraint, the difference in prediction error between the prediction algorithm obtained using learning data comprising data generated from the initial symmetry group and the initial probability law, and the prediction algorithm obtained using learning data comprising data generated from the determined subgroup and the subgroup probability law.

8. The method according to claim 1, wherein a plurality of optimization constraints are taken into account in the optimization technique.

9. The method according to claim 1, wherein the optimization technique is an optimization of a quadratic target function under quadratic optimization constraints.

10. The method according to claim 1, wherein the subgroup has a dimension, at least one constraint comprising a limitation of at least one moment of the subgroup probability law with a bound.

11. The method according to claim 1, wherein the initial probability law is obtained from the likelihood of the transformations associated with the initial symmetry group measured for a set of inputs corresponding to the expected inputs within the framework of a specific use of the prediction algorithm considered.

12. The method according to claim 1, wherein the initial probability law comprises a uniform distribution or a Gaussian distribution.

13. The method according to claim 1, wherein the initial symmetry group comprises a Lie group.

14. A computer program product comprising program instructions forming a computer program stored on a readable storage medium, the computer program being loadable on a data processing unit and implementing a method according to claim 1.

15. A readable storage medium comprising program instructions forming a computer program, the computer program being loadable on a data processing unit and implementing a method according to claim 1 when the computer program is implemented on the data processing unit.

16. The method according to claim 1, wherein the subgroup has a dimension, at least one constraint comprising a limitation of at least one moment of the subgroup probability law with an upper bound on the dimension of the subgroup or an upper bound on the variance of the subgroup probability law.

17. The method according to claim 1, wherein the initial symmetry group comprises the group of the roto-translations of the plane.
